(19) United States
(12) Patent Application Publication
(10) Pub. No.: US 2009/0045747 A1
(43) Pub. Date: Feb. 19, 2009

(54) Fluorescent lamp

(75) Inventor: Si Chung Noh, Gyeonggi-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Feelux Co., Ltd.

(21) Appl. No.: 12/228,629

(22) Filed: Aug. 13, 2008

(30) Foreign Application Priority Data
Aug. 13, 2007 (KR) 10-2007-0081158

(51) Int. Cl. H01J 13/46

(52) U.S. Cl. 315/56

(57) ABSTRACT

Disclosed herein is a fluorescent lamp. The fluorescent lamp is constituted by main tubes, subsidiary tubes having electrodes, and connection tubes each connecting the main tube to the subsidiary tube. Specifically, the fluorescent lamp includes a first stage main tube part having a first main tube, a second stage main tube part communicating with the first stage main tube part and having second and third main tubes, and a third stage subsidiary tube part communicating with the second stage main tube part and having first and second subsidiary tubes each having an electrode.

### CROSS REFERENCE TO RELATED APPLICATIONS

This application claims the benefit of Korean Patent Application No. 10-2007-0081158, filed on Aug. 13, 2007, which is incorporated by reference herein for any purpose.

1. Field of the Invention

The present invention relates to a fluorescent lamp, and more particularly, to a fluorescent lamp that includes a plurality of light emitting tubes disposed in parallel with each other to increase light intensity per installation area and has different fluorescent materials coated on interior surfaces of the light emitting tubes to provide improved color rendering properties and an aesthetic appearance.

2. Description of the Related Art

Generally, fluorescent lamps are disposed at a predetermined indoor or outdoor location and emit light through the supply of power. Recently, the fluorescent lamps have been disposed at various positions of businesses not only for illumination but also for decorative uses, such as display cabinets, show rooms, and the like, to obtain good visual effects from the fluorescent lamps.

Referring to FIG. 1, which shows a conventional fluorescent lamp as disclosed in Korean Patent No. 553,188 issued to the applicant of the present invention, the fluorescent lamp includes a tube shaped body 21, subsidiary tubes 23 disposed in parallel with the body 21 at opposites sides of the body 21 and extending inwardly a predetermined distance in the horizontal direction, and a connection terminal 22 formed in the horizontal direction on each inward end of the subsidiary tubes 23. According to this patent, plural fluorescent lamps can be connected in series without intermittent illumination at connected portions, thereby providing an improved appearance and illumination. However, since a single fluorescent lamp can only employ a light source having a single color, it is necessary to use a plurality of fluorescent lamps in order to obtain a variety of colors.

Further, to obtain a light source which permits a variety of colors and adjustment of brightness for improved color rendering properties, it is necessary to employ light sources for emitting a variety of colors in a number of lighting fixtures or to employ a system including a lighting controller, which burdens a general home with high costs and installation difficulty.

Moreover, when achieving high efficiency with a single lamp light source, an elongated lamp is conventionally used to increase light intensity. However, such an elongated lamp occupies a large installation area and is susceptible to breakage during transportation.

### SUMMARY OF THE INVENTION

The present invention is conceived to solve the problems of the conventional techniques as described above, and it is an aspect of the present invention to provide a fluorescent lamp which includes two or more tubes emitting different colors and integrated to each other to achieve an improved light intensity per installation area when coupled to a lighting fixture.

It is another aspect of the present invention to provide an integral fluorescent lamp which ensures a greater light intensity without increasing the height of the fluorescent lamp.

It is a further aspect of the present invention to a fluorescent lamp which includes two main tubes with different fluorescent materials coated on interior surfaces of the respective main tubes such that a plurality of colors can be obtained by a single integral lamp light source upon application of an electric current.

It is yet another aspect of the present invention to provide an integral lamp which includes a main tube and a subsidiary tube with different fluorescent materials coated on interior surfaces of the respective tubes such that a plurality of colors can be obtained using a single integral lamp light source upon application of an electric current.

It is yet another aspect of the present invention to provide an integral fluorescent lamp which permits additive mixing of various colors or additive mixing of Kelvin temperatures in different bands to constitute a single light source, thereby improving color rendering properties.

It is yet another aspect of the present invention to provide a fluorescent lamp which permits easy replacement with another fluorescent lamp in a single lighting fixture to provide a proper light source having various colors and brightness adjusted according to utility and function of an installation space.

In accordance with an aspect of the present invention, a fluorescent lamp includes main tubes, subsidiary tubes having electrodes, and connection tubes each connecting the main tube to the subsidiary tube. The fluorescent lamp includes a first stage main tube part having a first main tube; a second stage main tube part communicating with the first stage main tube part and having second and third main tubes; and a third stage subsidiary tube part communicating with the second stage main tube part and having first and second subsidiary tubes, each having an electrode.

The fluorescent lamp may include a first connection tube communicating with the first stage main tube part and the second stage main tube part, and a second connection tube communicating with the second stage main tube part and the third stage subsidiary tube part.

The first main tube, the second main tube, and the third main tube may be disposed in parallel with one another.

The first main tube, the second main tube, and the third main tube may be horizontally disposed. Further, the first and second subsidiary tubes may be disposed on at least one of an upper side and a lower side of the first main tube. The first main tube, the second main tube, and the third main tube may have two or more different fluorescent materials selectively coated on interior surfaces thereof.

The first main tube, the second main tube, and the third main tube may have two or more different fluorescent materials selectively coated on interior surfaces thereof. In one embodiment, at least one of a fluorescent material for a low Kelvin temperature and a fluorescent material for a high Kelvin temperature may be coated on the first main tube, and the other fluorescent material different from that of the first main tube may be coated on the interior surfaces of the second and third main tubes to express a plurality of colors based on different color temperatures upon application of an electric current. In another embodiment, two or more fluorescent materials may be selectively coated on the interior surfaces of the first, second and third main tubes to express two or more colors among red, green and blue light upon application of an electric current.

In a further embodiment, three fluorescent materials may be selectively coated on the interior surfaces of the first main tube, second main tube, third main tube, first subsidiary tube, and second subsidiary tube to express red, green and blue light upon application of an electric current.

### BRIEF DESCRIPTION OF THE DRAWINGS

The above and other features and advantages of the present invention will become apparent from the following description of preferred embodiments given in conjunction with the accompanying drawings, in which:

FIG. 1 is a front view of a conventional fluorescent lamp;

FIG. 2 is a front view of a fluorescent lamp according to one embodiment of the present invention;

FIGS. 3 and 4 are side views of a fluorescent lamp according to another embodiment of the present invention; and

FIGS. 5 and 6 are front views of a fluorescent lamp according to a further embodiment of the present invention.

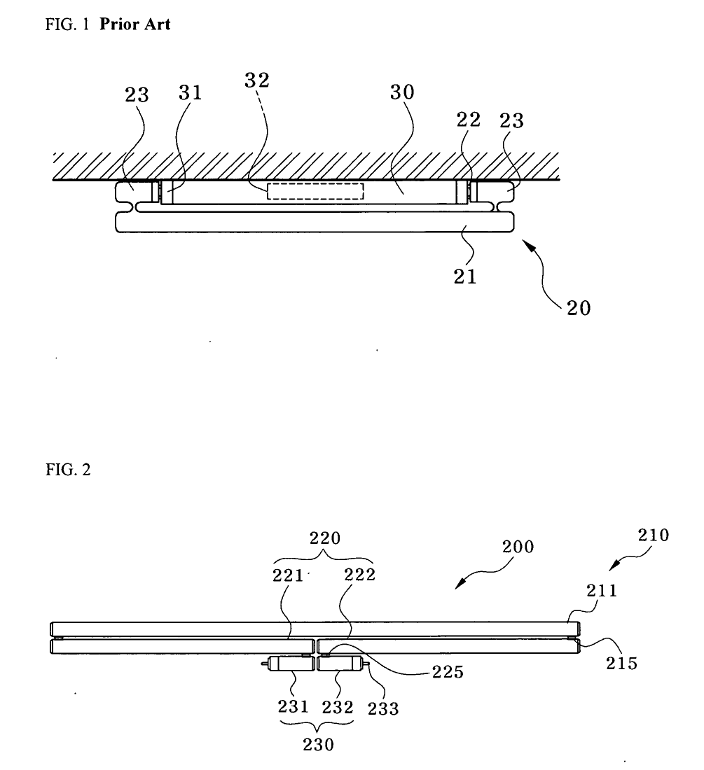

### DETAILED DESCRIPTION OF THE INVENTION

Exemplary embodiments of the present invention will be described in detail with reference to the accompanying drawings hereinafter. In the accompanying drawings, like elements or components are denoted by like reference numerals throughout. Herein, a detailed description of well-known functions or configurations (for example, a lighting fixture including a stabilizer not pertaining to the present invention) of the related art will be omitted for clarity of description.

Further, the exemplary embodiments of the present invention are given for clear understanding of the present invention to those skilled in the art, and do not limit the scope of the present invention.

The fluorescent lamp according to the present invention is an integral fluorescent lamp that includes a main tube having a fluorescent material coated on an interior surface of the main tube, a subsidiary tube having a connection terminal, and a connection tube connecting the main tube to the subsidiary tube for sealing the fluorescent lamp.

The interior surface of the main tube is coated with the fluorescent material to emit light upon application of an electric current. Additionally, the subsidiary tube and the connection tube may have or may not have the fluorescent material coated on the interior surfaces thereof, as needed. According to the present invention, although the connection tube is divided into a first connection tube and a second connection tube, these connection tubes have the same shape and functions, and are named according to usage locations.

Next, terminology and contents of techniques employed herein will be described.

Typically, a color of a fluorescent lamp is determined by a fluorescent material coated on an interior surface of the lamp. Herein, the term “low Kelvin temperature” indicates a warm tone and means a relatively low color temperature of a certain light source. The term “high Kelvin temperature” indicates a cool tone and means a relatively high color temperature.

According to the present invention, the low Kelvin temperature may be in the range of 1,600˜2,700 K, and the high Kelvin temperature may be in the range of 5,000˜10,000 K.

In the definition of color temperature, when the color of a certain material emitting visible light matches a color radiated from a black-body having a predetermined temperature, the temperature of the black-body is the color temperature of the material. Namely, the color temperature of the material is measured by the temperature (absolute temperature or Kelvin degree, K) of the black-body with the same chromaticity as that of the material. For example, light from an electric bulb has a color temperature of 2,800 K, and light from a fluorescent lamp has a color temperature of 4,500˜6,500 K. Sunlight has a color temperature of 5,400 K at noon and a color temperature of 6,500˜7,000 K when overcast, and a blue sky has a color temperature of 12,000˜18,000 K on a clear day. Further, general indoor lighting has a color temperature of 4,500 K. Here, a color temperature of 4,000 K is recommended for watching TV, a color temperature of 5,500 K is recommended for reading books, and a color temperature of 2,400 K is recommended for music listening and meditation.

In the definition of color rendering index, red and yellow-based colors are conspicuous under lighting with an incandescent electric lamp, whereas a blue-based color is conspicuous under light with a fluorescent lamp. As such, a quantitative measure of the ability of a light source to reproduce the colors of various objects in comparison with natural light is referred to as the “color rendering index (Ra).” When a light source has a color rendering index of 100, the light source emits light approaching natural light and provides pleasant feelings.

Generally, light from a light source having a high Kelvin temperature can give active feelings to an entire space of a room, whereas light from a light source having a low Kelvin temperature can give psychological calmness and stability.

FIG. 2 is a front view of a fluorescent lamp according to one embodiment of the present invention.

Referring to FIG. 2, the fluorescent lamp 200 according to this embodiment includes a first stage main tube part 210 having a first main tube 211, a second stage main tube part 220 communicating with the first stage main tube part 210 and having second and third main tubes 221 and 222, and a third stage subsidiary tube part 230 communicating with the second stage main tube part 220 and having first and second subsidiary tubes 231 and 232 each having an electrode such as a filament. The first and second subsidiary tubes 231 and 232 are provided with connection terminals. Further, the fluorescent lamp 200 includes a first connection tube 215 communicating with the first stage main tube part 210 and the second stage main tube part 220, and a second connection tube 225 communicating with the second stage main tube part 220 and the third stage subsidiary tube part 230. In other words, according to this embodiment, the first stage main tube part 210 is provided in a first stage, the second stage main tube part 220 is provided in a second stage, and the third stage subsidiary tube part 230 is provided in a third stage.

As shown in FIG. 2, the first stage main tube part 210, the second stage main tube part 220, and the third stage subsidiary tube part 230 are connected by the first connection tube 215 and the second connection tube 225 to constitute an integrally sealed fluorescent lamp. Further, the first main tube 211, the second main tube 221, and the third main tube 222 may be disposed in parallel with one another.

To provide a plurality of colors based on different Kelvin temperatures upon application of an electric current, two or more fluorescent materials may be selectively coated on interior surfaces of the first main tube 211, the second main tube 221, and the third main tube 222.

In one implementation, at least one of a fluorescent material for a low Kelvin temperature and a fluorescent material for a high Kelvin temperature is coated on the first main tube 211, and the other fluorescent material different from that of the first main tube 211 is coated on the second or third main tube 221 or 222 to express a plurality of colors based on different Kelvin temperatures upon application of an electric current.

In another implementation, two or more fluorescent materials may be selectively coated on the interior surfaces of the first main tube 211, the second main tube 221, and the third main tube 222 to express two or more colors among red, green and blue light upon application of the electric current.

According to this embodiment, the connection terminal 233 has a connection pin shape and the electrode (filament, not shown) is provided inside the subsidiary tube as in an internal electrode type fluorescent lamp. However, the present invention is not limited to this configuration, and can be embodied in various forms such as an external electrode type fluorescent lamp wherein an electrode (conductor) is formed on an outer surface of a subsidiary tube.

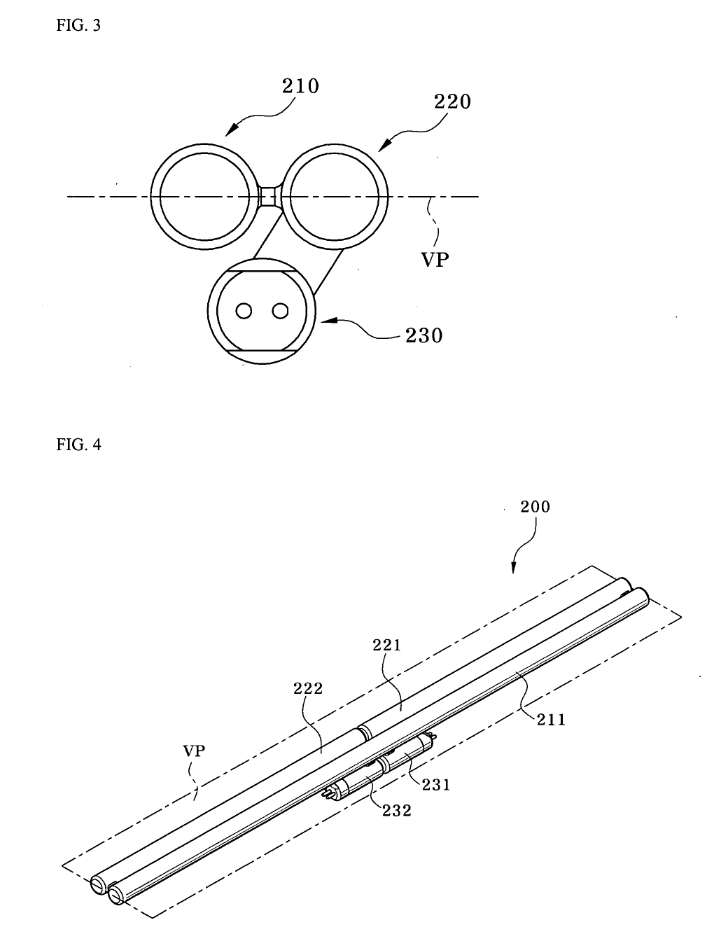

FIGS. 3 and 4 are side views of a fluorescent lamp according to another embodiment of the present invention.

Substantially the same components as those of the above embodiment will be denoted by the same reference numerals and a detailed description thereof will be omitted herein.

Referring to FIGS. 3 and 4, the fluorescent lamp 200 according to this embodiment has a first main tube 211, a second main tube 221, and a third main tube 222 which are horizontally disposed. Herein, the term “horizontally disposed” includes an unavoidable tolerance caused by manufacturing tolerance. Further, to lower an overall height of the fluorescent lamp 200, first and second subsidiary tubes 231 and 232 are disposed on at least one of an upper side and a lower side of the first main tube 211. For example, with the first main tube 211, second main tube 221, and third main tube 222 disposed on an imaginary identical plane VP, the first and second subsidiary tubes 231 and 232 are disposed to at least one of the upper and lower sides of the imaginary identical plane VP, thereby lowering the overall height of the fluorescent lamp.

In this case, it is desirable that the first main tube 211, first subsidiary tube 231 and the second subsidiary tube 232 constitute a triangular shape when viewed from one side of the fluorescent lamp. At this time, a holder (not shown) may be additionally provided to each separation between the first main tube 211, first subsidiary tube 231 and the second subsidiary tube 232 to prevent damage of the fluorescent lamp.

Although the holder has a hollow shape such as the connection tube in this embodiment, the holder may be a solid tube or have a similar structure to a fluorescent lamp reinforcement structure as disclosed in Korean Patent No. 0382393.

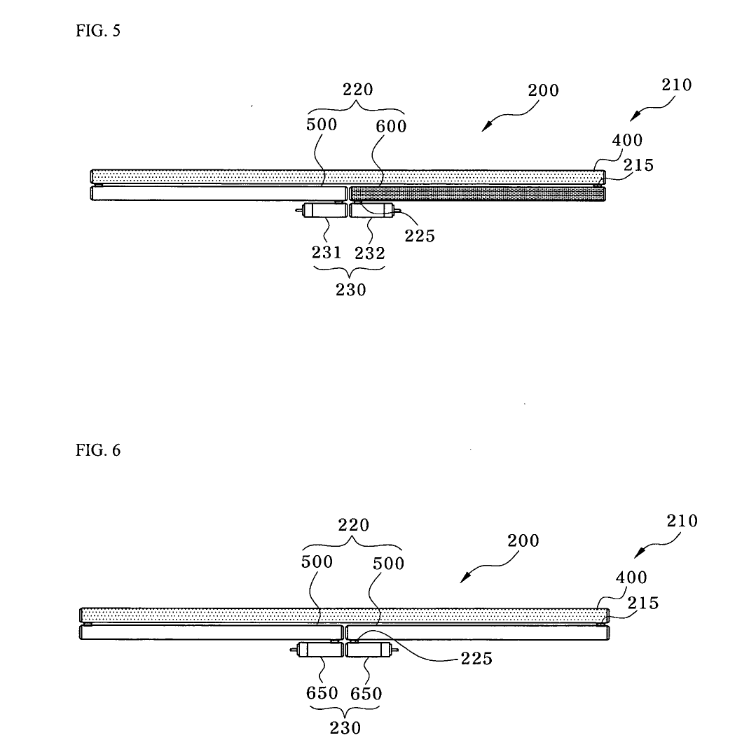

FIGS. 5 and 6 are front views of a fluorescent lamp according to a further embodiment of the present invention.

Referring to FIG. 5, in the fluorescent lamp of this embodiment, a first main tube 400 of the first stage main tube part 210 is configured to emit red light, a second main tube 500 of the second stage main tube part 220 is configured to emit green light, and a third main tube 600 of the second stage main tube part 220 is configured to emit blue light, so that three primary colors of R, G and B can be obtained from a single light source. As such, two or more fluorescent materials may be selectively coated on the interior surfaces of the first, second and third main tubes 400, 500 and 600 to emit two or more colors among red, green and blue light, whereby the fluorescent lamp can express plural colors based on different Kelvin temperatures upon application of an electric current.

Referring to FIG. 6, in the fluorescent lamp of this embodiment, the first main tube 400 of the first stage main tube part 210 is configured to emit red light, the second and third main tubes 500 and 600 of the second stage main tube part 220 are configured to emit green light, and first and second subsidiary tubes 231 and 232 of the third stage subsidiary tube part 230 are configured to emit blue light, so that three primary colors of R, G and B can be obtained from a single light source. As such, three fluorescent materials may be selectively coated on the interior surface of the first main tube 400, second main tube 500, third main tube 600, first subsidiary tube 231 and second subsidiary main tube 232 to emit red, green and blue light, whereby the fluorescent lamp can express plural colors based on different Kelvin temperatures upon application of an electric current.

As apparent from the above description, the integral fluorescent lamp according to the present invention includes two or more tubes which can be disposed in parallel with each other in a narrow space, thereby increasing light intensity per installation area.

Additionally, according to the present invention, the fluorescent lamp is constituted by three stages to reduce the height of the fluorescent lamp, thereby enabling a reduction of the installation area.

Further, according to the present invention, the fluorescent lamp realizes a light source which provides an additive mixture of various colors, thereby improving an aesthetic appearance.

Considering that sunlight is composed of warm tones (low Kelvin temperature) and cool tones (high Kelvin temperatures), the light source obtained by the present invention permits an additive mixture of low Kelvin temperature and high Kelvin temperature, and thus has excellent color rendering properties.

Further, according to the present invention, the fluorescent lamp can provide a variety of colors or color rendering properties adjusted according to utility and function of an installation space, thereby realizing a light source suitable for the installation space.

Furthermore, according to the present invention, the fluorescent lamp permits a simple replacement operation such that a plurality of fluorescent lamps for various utilities can be used in a single lighting fixture, thereby increasing efficiency of the operation and permitting easy change in characteristics of the installation space.

Although the present invention has been described with reference to the embodiments and the accompanying drawings, the present invention is not limited to the embodiments and the drawings. It should be understood that various modifications and changes can be made by those skilled in the art without departing from the spirit and scope of the present invention as defined by the accompanying claims.

What is claimed is:

1. A fluorescent lamp with main tubes, subsidiary tubes having electrodes, and connection tubes each connecting the main tube to the subsidiary tube, the fluorescent lamp comprising:
a first stage main tube part having a first main tube;
a second stage main tube part communicating with the first stage main tube part and having second and third main tubes; and
a third stage subsidiary tube part communicating with the second stage main tube part and having first and second subsidiary tubes each having an electrode.

2. The fluorescent lamp according to claim 1, further comprising:
a first connection tube communicating with the first stage main tube part and the second stage main tube part, and
a second connection tube communicating with the second stage main tube part and the third stage subsidiary tube part.

3. The fluorescent lamp according to claim 2, wherein the first main tube, the second main tube, and the third main tube are disposed in parallel with one another.

4. The fluorescent lamp according to claim 2, wherein the first main tube, the second main tube, and the third main tube are horizontally disposed.

5. The fluorescent lamp according to claim 4, wherein the first and second subsidiary tubes are disposed on at least one of an upper side and a lower side of the first main tube.

6. The fluorescent lamp according to claim 5, wherein the first main tube, the second main tube, and the third main tube have two or more different fluorescent materials selectively coated on interior surfaces thereof.

7. The fluorescent lamp according to claim 2, wherein the first main tube, the second main tube, and the third main tube have two or more different fluorescent materials selectively coated on interior surfaces thereof.

8. The fluorescent lamp according to claim 7, wherein at least one of a fluorescent material for a low Kelvin temperature and a fluorescent material for a high Kelvin temperature is coated on the interior surface of the first main tube, and the other fluorescent material different from that of the first main tube is coated on the interior surfaces of the second and third main tubes to express a plurality of colors based on different color temperatures upon application of an electric current.

9. The fluorescent lamp according to claim 7, wherein two or more fluorescent materials are selectively coated on the interior surfaces of the first, second and third main tubes to express two or more colors among red, green and blue light upon application of an electric current.

10. The fluorescent lamp according to claim 2, wherein three fluorescent materials are selectively coated on the interior surfaces of the first main tube, second main tube, third main tube, first subsidiary tube, and second subsidiary tube to express red, green and blue light upon application of an electric current.
